(19) United States
(12) Patent Application Publication
(10) Pub. No.: US 2004/0084120 A1
(43) Pub. Date: May 6, 2004

(54) Tire with marked layers

(76) Inventors: Jesse Arnold, Simpsonville, SC (US); Christopher Sean Madden, Greenville, SC (US)

Correspondence Address: Michelin North America, Inc., Intellectual Property Department, P.O. Box 2026, Greenville, SC, 29602, US

(21) Appl. No.: 10/305,503

(22) Filed: Nov. 27, 2002

Related U.S. Application Data
(60) Provisional application No. 60/334,817, filed on Nov. 30, 2001.

(51) Int. Cl. B60C 1/00; B60C 5/00; B60C 19/00; B60C 25/00; B29D 30/54; B29C 73/00; C09K 11/00

(52) U.S. Cl. 152/151; 152/450; 156/67; 156/96; 156/128.1; 156/64

(57) ABSTRACT

The present invention is a tire comprising a tread and layers radially interior to said tread, wherein at least one layer comprises a dye or pigment that fluoresces when exposed to ultraviolet light. The fluorescent dye may be on the surface of the layer, or dispersed throughout the layer. The present invention also comprises a method of inspecting a tire for proper placement of components comprising shining an ultraviolet light onto a cut section of the aforesaid layer. The invention also includes a method of re-treading a tire where the fluorescent layer is interior to the tread, and detecting the fluorescence of the layer is a signal to cease tread removal operations. In one to embodiment of the invention, the tire has at least one steel belt, and the fluorescent layer is a tape covering the edge of the belt. In another embodiment of the invention, the tire is a non-pneumatic tire.

In one embodiment of the invention, a different fluorescent dye is used in at least two interior layers of the tire.

### FIELD OF THE INVENTION

The present invention is in the field of tires.

### BACKGROUND OF THE INVENTION

Millions of automobile and truck tires are sold each year throughout the world. Though perhaps not readily apparent, the modern pneumatic tire is a complicated arrangement of rubber, steel, carbon black, and other materials. It requires precision in manufacture, and when retreading, precision in affixing a new tread to an old carcass.

A variety of methods have been used to improve the processes of building and re-treading a tire.

U.S. Pat. No. 5,206,720 issued 27 Apr. 1993 to Clothiaux, et al., discloses the use of fluorescent lamps for monitoring the lateral edges of tire components during tire building.

U.S. Pat. No. 4,032,785 issued 28 Jun. 1977 to Green, et al. discloses a means for examining a tire consisting of an X-ray machine and a monitor which reproduces the X-ray picture on a fluorescent screen.

U.S. Pat. No. 3,809,900 issued 7 May 1994 to Steffel discloses a means for examining a tire consisting of an X-ray machine and a monitor which reproduces the X-ray picture on a fluorescent screen.

U.S. Pat. No. 3,793,526 issued 19 Feb. 1974 to Collmann, et al. discloses a means for examining a tire consisting of an X-ray machine and a monitor which reproduces the X-ray picture on a fluorescent screen.

U.S. Pat. No. 3,754,138 issued 21 Aug. 1973 to Kurstedt discloses the use of metallic particles that fluoresce upon exposure to X-rays, and fluorescence detectors to determine the position of a layer within a tire ply.

U.S. Pat. No. 3,261,388 issued 19 Jul. 1966 to Kovac, et al. discloses a colored ply made of a filamentary textile material which is located between the tread and the carcass which functions as a tread wear indicator, and is used as a guide in re-treading operations.

A number of references have disclosed coloration of tires for cosmetic, safety, or manufacturing reasons.

U.S. Pat. No. 5,840,138 issued 24 Nov. 1998 to Calevich, et al., discloses the use of fluorescent dye for harmonic marking of tires.

U.S. Pat. No. 4,969,350 issued 13 Nov. 1990 to Fogal discloses applying a fluorescent material to the interior of a tire, then pressurizing the tire, in order to detect punctures in a tire.

U.S. Pat. No. 4,693,118, issued 15 Sep. 1987 to Roberts discloses the injection of a powdered fluorescent pigment into the interior of a tire, with a propellant, in order to detect leaks.

U.S. Pat. No. 3,607,498 issued 21 Sep. 1971 to Kubota discloses a tire with decorative fluorescent sidewalls.

U.S. Pat. No. 3,577,261 issued 4 May 1971 to Klar discloses a method for identifying rubber stocks by coloring an adhesive layer by placing it atop a rubber layer.

U.S. Pat. No. 1,895,088 issued 24 Jan. 1933 to Taylor discloses coloring the sidewall of a tire.

U.S. Pat. No. 647,987 to Roney, issued 24 Apr. 1900, discloses a bicycle tire with a thin layer of black rubber above the main tier of white rubber, so that a white mark shows on the black rubber at a place of puncture.

WO99/24271 by Sweetman, et al., published 12 May 1999 discloses fluorescent or phosphorescent material in the sidewall recesses of a tire.

DE19613801 by Rogal, published 9 Oct. 1997 discloses fluorescent and phosphorescent pigments used to color the outer surface of a tire.

FR2796302 by Boissiere, published 19 Jan. 2001, discloses a bright wheel made from phosphorescent or fluorescent material, so that the user can be seen at night.

JP10000907 by Matsushita published 6 Jan. 1998 discloses a tire composed partly of a luminous phosphor to prevent traffic accidents at night.

JP1074107 by Okamatsu, published 20 Mar. 1989, discloses mixing fluorescent paint into the material of a tire to improve recognition at night.

KR9702602 by Hankook Tire Mfg. Co., published 6 Mar. 1997, discloses the use of a fluorescent dye to detect the flowness of the tire side part.

KR9612824 by Kono, Inc., published 24 Sep. 1996, discloses a tire cord dyed with a pink fluorescent dye, to help judge the time of replacing an airplane tire.

KR96046789 by Kumho Co. Ltd., published 11 Apr. 1996 discloses adding phosphorescent or luminescent material to a tire to make a luminous white rim.

U.S. Pat. No. 5,704,999 issued 6 Jan. 1998 to Lukich, et al., discloses a colored wear indicator strip composed of a silica-reinforced elastomer located between the carcass plies of a multiple carcass tire.

U.S. Pat. No. 5,303,756 issued 19 Apr. 1994 to Hill, discloses a tire with a plurality of colored wear-indicating members in a housing, extending radially from the tread.

U.S. Pat. No. 4,226,274 issued 7 Oct. 1980 to Awaya, et al., discloses a colored tread wear indicator, in the form of the letter K.

U.S. Pat. No. 3,833,040 issued 3 Sep. 1974 to Bins, discloses recovering the tread with a material of a different color than the underlying tread.

U.S. Pat. No. 3,814,160 issued 4 Jun. 1974 to Creasey, discloses a tread-wear indicator where the tread has a surface portion of a first color, and a subsurface portion of a second color.

U.S. Pat. No. 3,770,040, issued 6 Nov. 1973 to De Cicco, discloses coating the bottom of a tread groove with phosphorous so a photo detector could estimate the degree of tread wear.

U.S. Pat. No. 3,578,055 issued 11 May 1971 to French, et al. discloses a colored tread wear marker secured in a recess of the tread.

U.S. Pat. No. 3,516,467 to Sims, issued 23 Jun. 1970, discloses a colored structure in the sidewall or tread which becomes exposed when the tire is worn.

U.S. Pat. No. 2,102,784 to Bridges, issued 21 Dec. 1937, discloses a tread insert for indicating wear whose color contrasts with that of the tread. United States Statutory Invention Registration No. H1283 to Porto, et al., published 1 Feb. 1994, discloses a tread composed of different plies in layers so that the tread displays different colors and patterns as it wears down.

FR2741300 to Sabban, published 23 May 1997, discloses a tread wear indicator of different colors in the tread, which are exposed as the tread wears.

GB 2331052 to Sweetman, et al., published 12 May 1999 discloses a tire with a fluorescent material molded into recesses in the sidewall, or as an outer coating.

GB2276130 to Hunt, published 21 Sep. 1994, discloses a tread composed of marker layers to indicate wear, where one of the marker layers can be fluorescent.

GB2269347 to Crump, published 2 Sep. 1994, discloses a bright yellow tread wear depth indicator placed inside a black tread at a certain depth.

GB2265586 to Hare, published 6 Oct. 1993, discloses a strip indicator embedded in a tire tread to indicate treadwear. The indicator may be in colored layers, and may be luminescent, e.g. of fluorescent or phosphorescent material.

GB357,419 to Coleman, published 24 Sep. 1931, discloses tire treads, the softer grooves of which are differently colored.

GB2262489 to Quibell, published 23 Jun. 1993, discloses a tire tread with one or two layers of colored material that become exposed when the tread wears down.

GB2268715 to Mcinuity, published 16 Jul. 1992, discloses a tire tread with one or two layers of colored material that become exposed when the tread wears down. The layers may be in the tread and in the sidewall.

GB2243584 to Antonio, published 6 Nov. 1991, discloses a tread depth indicator secured in a groove of a tire which may be composed of several layers, two of which may be fluorescent.

GB 2326625 to Colletti, et al., published 30 Dec. 1998, discloses placing a different colored rubber below the surface of a tire tread as a wear indicator.

GB2216851 to Bromley, published 18 Oct. 1989, discloses a tire tread with a layer of red material that becomes exposed when the tread wears down.

GB1364988 to Rubberfabriek Vredestein, published 29 Aug. 1974, discloses grooves in a tire with radially inner portions having a different color than the tread material.

GB1262669 to Baxter, published 2 Feb. 1972 discloses two colored layers in a tire tread to indicate wear.

GB976,967 to Arthur, published 2 Dec. 1964, discloses transversely extending areas within the tread having a different color, to be used as wear indicators.

GB448,223 to Amsler, published 4 Jun. 1936 discloses a rubber plug for insertion into a tread to indicate treadwear, where to plug may have two colored layers.

However, it would be advantageous to have an improved means of inspecting a freshly manufactured tire for the placement of components, and an improved means of stopping tread removal operations in time to not damage belt components during a re-treading procedure.

### SUMMARY OF THE INVENTION

The present invention is a tire comprising a tread and layers radially interior to said tread, wherein at least one layer comprises a fluorescent dye or pigment that fluoresces when exposed to ultraviolet light. The fluorescent dye may be on the surface of the layer, or dispersed throughout the layer. The present invention also comprises a method of inspecting a tire for proper placement of components comprising shining an ultraviolet light onto a cut section of the aforesaid layer. The invention also includes a method of re-treading a tire where the fluorescent layer is interior to the tread, and detecting the fluorescence of the layer is a signal to cease tread removal operations. In one embodiment of the invention, the tire has at least one steel belt, and the fluorescent layer is a tape covering the edge of the belt. In another embodiment of the invention, the tire is a non-pneumatic tire.

In one embodiment of the invention, a different fluorescent dye is used in at least two layers of the tire radially interior to the tread.

The present invention is also a tire comprising a tread wherein the tread includes a dye that fluoresces upon exposure to ultraviolet light. In one embodiment of the invention, the tread comprises one or more layers, and at least one layer includes a dye that fluoresces upon exposure to ultraviolet light.

Therefore it is an object of the present invention to provide a ready means for inspecting a tire in a manufacturing operation.

It is a further object of the invention to provide a method for retreading a tire.

These and other objects of the invention will become apparent upon review of the present specification, drawings, and claims.

### BRIEF DESCRIPTION OF THE DRAWINGS

FIG. 1 is an illustration of a pneumatic tire, showing the tread, a layer beneath the tread, two steel belts, and a carcass.

FIG. 2 is an illustration of a pneumatic tire showing a tape covering the edge of a steel belt.

FIG. 3 is a functional diagram showing a fluorescence detector sending a signal to a rasping machine to stop removing the tire tread.

### DETAILED DESCRIPTION OF THE INVENTION

The present invention is a tire comprising a tread and layers radially interior to said tread, wherein at least one layer comprises a dye or pigment that fluoresces when exposed to ultraviolet light. The fluorescent dye may be on the surface of the layer, or dispersed throughout the layer. The present invention also comprises a method of inspecting a tire for proper placement of components comprising shining an ultraviolet light onto a cut section of the aforesaid layer. The invention also includes a method of re-treading a tire where the fluorescent layer is interior to the tread, and detecting the fluorescence of the layer is a signal to cease tread removal operations. In one embodiment of the invention, the tire has at least one steel belt, and the fluorescent layer is a tape covering the edge of the belt. In another embodiment of the invention, the tire is a non-pneumatic tire.

In one embodiment of the invention, a different fluorescent dye is used in at least two interior layers of the tire. By “interior”, it is meant that the layer is interior to the tread and interior to the sidewall.

In one embodiment the tire is a cured tire. In another embodiment of the invention, the tire is an uncured tire

In one embodiment, the invention is a method of inspecting a manufacturing process. A fluorescent dye is added to an interior layer of a tire, an ultraviolet light is shone on the layer, and the position of the layer with respect to another layer is determined. In another embodiment, the invention is a way of inspecting a manufacturing process for a rubber product that includes layers. A fluorescent dye is added to a layer, an ultraviolet light is shone on the layer, and the position of the layer with respect to another layer of the tire is determined.

As used herein, the term “fluorescent dye” includes a fluorescent pigment. All publications cited herein are specifically incorporated by reference.

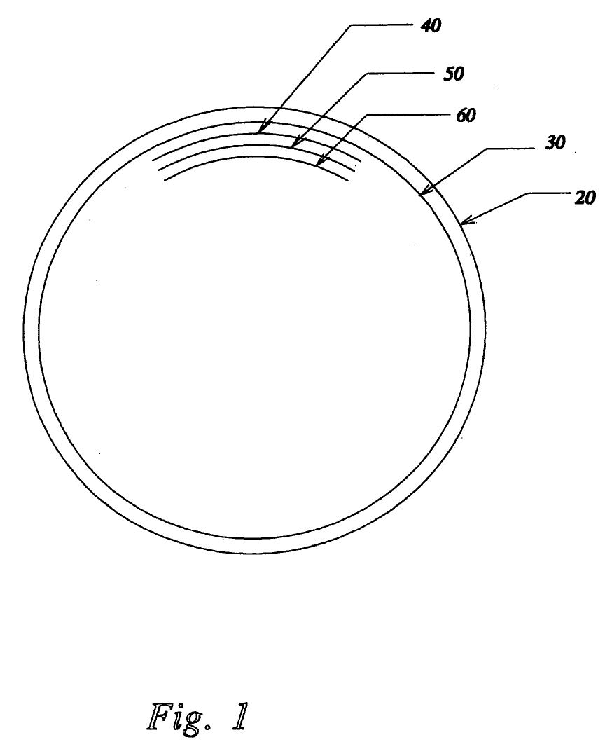

FIG. 1 is an illustration of a pneumatic tire (10), showing the tread (20), a layer beneath the tread (30), two steel belts (40, 50), and a carcass (60). According to the present invention, one of the layers beneath the tread is suffused with a fluorescent dye, or is coated at its surface with a fluorescent dye. Different layers of rubber within a tire are often the same jet-black color, and very difficult to distinguish with the naked eye. These layers are jet-black because typically they contain carbon black filler.

Inspection of Component Placement

The determination of whether components of a tire have been properly placed is often quite difficult. The present invention permits ready identification of the layers of a tire, since under ultraviolet light one layer fluoresces. Therefore, the invention permits ready inspection within the manufacturing plant of the proper placement of components of the tire.

In one embodiment of the invention, only one interior layer of the tire is fluorescent. In another embodiment of the invention, more than one interior layer of the tire is fluorescent, and the layers are not adjacent to one another. In another embodiment of the invention, the fluorescent layers may be adjacent to one another. In a further embodiment of the invention, the fluorescent interior layers may contain different fluorescent compounds. The tire may be a cured or an uncured tire.

Retreading

The market for retreaded pneumatic tires includes trucking and aircraft. In the trucking market, the carcass of a tire is expected to last several hundred thousand miles, and be amenable to having a new tread adhered to it several times. New truck tires are quite expensive, and are therefore bought with the expectation that the long service life of the carcass (also known as the “casing”), and the low comparative cost of retreading will offset the high initial cost.

A variety of procedures and different types of equipment are available for use in recapping or retreading pneumatic tires. One of the first steps in retreading a worn tire is to remove existing tread material from the tire carcass by a rasping procedure known as buffing. Then one or more layers of uncured rubber or retreading material is applied with appropriate bonding agents to the buffed tire carcass. Alternatively, the uncured rubber may be stitched to the buffed carcass.

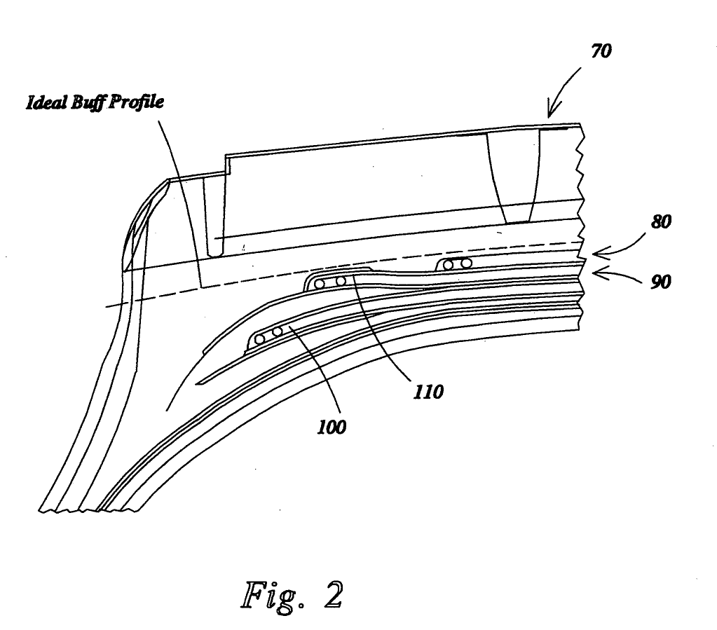

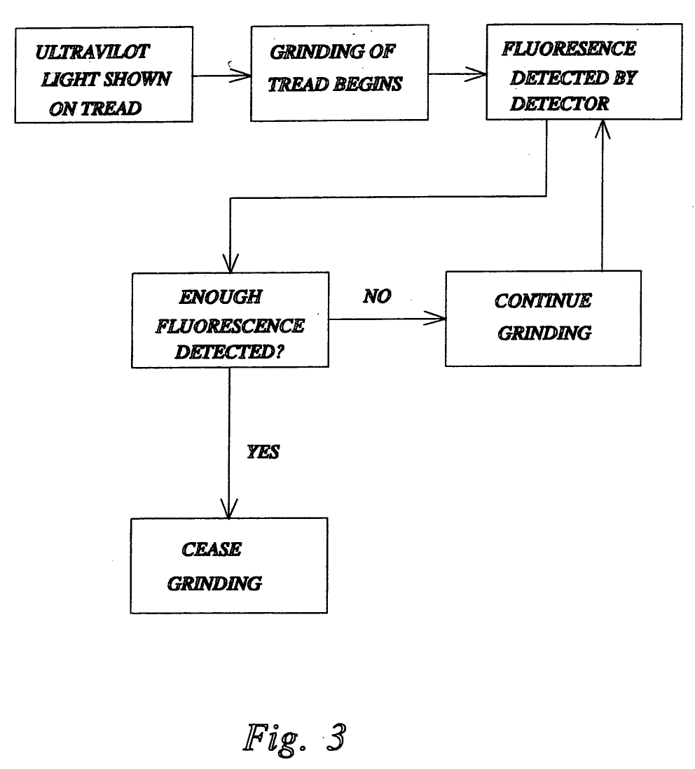

If the buffing operation is continued too far, and the steel belts of the tire are exposed, the tire probably must be discarded, since its structural integrity may have been compromised. According to the present invention, ultraviolet light is shone on the tire during the buffing operation. When a sufficient level of fluorescence is detected, either by a human operator or a fluorescence detector, the buffing operation is stopped. In one embodiment of the invention, an adhesive tape (110) is placed over the edge of a steel belt (90) (see FIG. 2) during the original manufacture of the tire. The adhesive tape (110) is suffused with, or coated with, a fluorescent compound. During the tread removal operation, when a sufficient amount of fluorescence is detected from this tape, the tread removal operation is stopped (see FIG. 3). Fluorescence can be measured with a fluorescence detector [one such detector is a Lut 1-4 Luminescence Scanner (SICK Optic-Electronic, Inc., Eden Prairie, Minn.)].

Types of Fluorescent Dyes and Pigments Useful with the Present Invention

Fluorescence is the emission of electromagnetic radiation by a substance as a result of the absorption of energy from radiation, which may be electromagnetic or particulate, provided that the emission continues only as long as the stimulus producing it is maintained. That is, fluorescence is a luminescence that ceases within about 10 exp (−8) seconds after excitation stops. In one embodiment of the present invention, the excitation is provided by light in the ultraviolet spectrum, i.e., electromagnetic radiation from about 400 nanometers to about 10 nanometers in wavelength.

Useful fluorescent dyes include, but are not necessarily limited to those that are miscible with rubber, and do not substantially affect physical characteristics of the tire such as cohesion, tensile modulus, and hysteresis. Included in this category are dyes such as TRY-33 (CAS No. 801-00023-5021-P), TRY-53, MT-6172-IB (Day-Glo Color Corporation, Cleveland, Ohio). In one embodiment, the dye is present in an amount up to five in one hundred parts by weight of the rubber composition. TRY-33 gives a greenish glow upon exposure to ultraviolet light. Other useful fluorescent dyes may be found in the Colour Index (Society of Dyers and Colourists and American Association of Textile Chemists and Colorists), incorporated herein by reference.

Types of Rubber Useful with the Present Invention

Tire layers according to the present invention may be composed of natural or synthetic elastomers. Useful are dienic elastomers. “Diene” elastomer or rubber is understood to mean, in known manner, an elastomer resulting at least in part (i.e., a homopolymer or a copolymer) from diene monomers (monomers bearing two double carbon-carbon bonds, whether conjugated or not).

In general, “essentially unsaturated” diene elastomer is understood here to mean a diene elastomer resulting at least in part from conjugated diene monomers, having a content of members or units of diene origin (conjugated dienes) which is greater than 15% (mol %).

Thus, for example, diene elastomers such as butyl rubbers or copolymers of dienes and of alpha-olefins of the EPDM type do not fall within the preceding definition, and may in particular be described as “essentially saturated” diene elastomers (low or very low content of units of diene origin which is always less than 15%).

Within the category of “essentially unsaturated” diene elastomers, “highly unsaturated” diene elastomer is understood to mean in particular a diene elastomer having a content of units of diene origin (conjugated dienes) which is greater than 50%.

These definitions being given, the following are understood more particularly to be meant by diene elastomer capable of being used in the compositions according to the invention:

(a)—any homopolymer obtained by polymerisation of a conjugated diene monomer having 4 to 12 carbon atoms;

(b)—any copolymer obtained by copolymerisation of one or more dienes conjugated together or with one or more vinyl aromatic compounds having 8 to 20 carbon atoms;

(c)—a copolymer of isobutene and isoprene (butyl rubber), and also the halogenated, in particular chlorinated or brominated, versions of this type of copolymer.

Although it applies to any type of diene elastomer, the person skilled in the art of tyres will understand that the present invention is used first and foremost with essentially unsaturated diene elastomers, in particular those of type (a) or (b) above.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl aromatic compounds are, for example, styrene, ortho-, meta- and para-methylstyrene, the commercial mixture “vinyltoluene”, para-tert.-butylstyrene, methoxystyrenes, chlorostyrenes, vinylnesitylene, divinylbenzene and vinylnaphthalene.

In summary, the diene elastomer of the composition according to the invention is selected from the group of highly unsaturated diene elastomers which consists of polybutadienes (BR), polyisoprenes (IR), natural rubber (NR), butadiene copolymers, isoprene copolymers and mixtures of these elastomers. Such copolymers are more preferably selected from the group which consists of butadiene-styrene copolymers (SBR), butadiene-isoprene copolymers (BIR), isoprene-styrene copolymers (SIR) and isoprene-butadiene-styrene copolymers (SBIR).

Of course, the compositions of the invention may contain a single diene elastomer or a mixture of several diene elastomers, the diene elastomer or elastomers possibly being used in association with any type of synthetic elastomer other than a diene elastomer, or even with polymers other than elastomers, for example thermoplastic polymers.

Types of Fillers Useful with the Present Invention

The white or inorganic filler used as reinforcing filler may constitute all or only part of the total reinforcing filler, in this latter case associated, for example, with carbon black. In the present application, “reinforcing inorganic filler”, in known manner, is understood to mean an inorganic or mineral filler, whatever its colour and its origin (natural or synthetic), also referred to as “white” filler or sometimes “clear” filler in contrast to carbon black, this inorganic filler being capable, on its own, without any other means than an intermediate coupling agent, of reinforcing a rubber composition intended for the manufacture of tyres, in other words which is capable of replacing a conventional tyre-grade carbon black filler in its reinforcement function.

The reinforcing inorganic filler may be a mineral filler of the siliceous or aluminous type, or a mixture of these two types of fillers.

Various Additives

The rubber compositions according to the invention also contain all or part of the additives usually used in sulphur-cross-linkable diene rubber compositions intended for the manufacture of tyres, such as, for example, plasticisers, extender oils, pigments, protective agents of the type antioxidants, antiozonants, a cross-linking system based either on sulphur or on sulphur donors and/or peroxide and/or bismaleimides, vulcanisation accelerators, vulcanisation activators, methylene acceptors and donors, etc. There may also be associated with the reinforcing inorganic filler, if necessary, a conventional non-reinforcing white filler, such as particles of clay, bentonite, talc, chalk, kaolin or titanium oxides.

Fluorescent Tire Layer Formulations According to the Invention

The invention will be further understood with reference to the following non-limiting examples.

### EXAMPLE 1

One part per hundred by weight of a fluorescent tracer dye, TRY-33, was added to a small quantity of a rubber tire compound composed of natural rubber. This small mass of rubber was then adhered to a piece of the same type of rubber sans TRY-33. Upon exposure to ultraviolet light, the compound containing the dye appeared greenish, and was easily distinguishable from the compound without the dye.

I claim:

1. A tire wherein the tire comprises a tread and layers radially interior to said tread, wherein at least one layer comprises a dye that fluoresces upon exposure to ultraviolet light.

2. A tire comprising a carcass including layers, wherein at least one of said layers comprises a dye that fluoresces upon exposure to ultraviolet light.

3. A tire comprising a tread and a layer of rubber beneath the tread, wherein the layer of rubber beneath the tread comprises a dye that fluoresces upon exposure to ultraviolet light.

4. A tire comprising a tread, interior to which is a first layer comprising a steel belt, interior to which is a second layer comprising a steel belt, wherein the first layer comprises a dye that fluoresces upon exposure to ultraviolet light.

5. A tire comprising a tread, interior to which is a first layer comprising a steel belt, interior to which is a second layer comprising a steel belt, wherein the second layer comprises a dye that fluoresces upon exposure to ultraviolet light.

6. A tire comprising at least two layers comprising steel belts, wherein at least one layer between the steel belts comprises a fluorescent dye.

7. The tire of claim 6, wherein the dye fluoresces upon exposure to ultraviolet light.

8. A tire comprising at least one steel belt having an edge, wherein a tape covers at least a portion of the edge, wherein the tape comprises a fluorescent dye.

9. The tire of claim 8, wherein the dye fluoresces upon exposure to ultraviolet light.

10. A method of inspecting a tire having an exterior surface, an interior surface, and a fluorescent layer between the interior and exterior surfaces, comprising the steps of:
a. cutting a tire to expose the interior of the tire; and
b. shining an ultraviolet light on the interior.

11. The method of claim 10, further comprising wherein the steel belt has at least one edge, and the edge is covered with a tape, and the tape comprises the fluorescent layer.

12. The method of claim 10, further comprising wherein a fluorescence detector detects the fluorescent layer, and the detector sends a signal to a tread removal machine to stop removing the tread.

13. A method of retreading a tire having a tread and one or more steel belts radially interior to the tread, wherein the tire has a fluorescent layer immediately radially interior to the tread, comprising the step of removing the tread until the fluorescent layer is detected.

14. The method of claim 13, wherein the detection is effected by means of an automatic sensor.

15. A non-pneumatic tire comprising layers, wherein one of the interior layers is fluorescent.

16. The tire of claim 1, wherein the fluorescent layer comprises a material selected from the group consisting of dyes and pigments that fluoresce upon exposure to ultraviolet light.

17. The tire of claim 1, wherein the layer has an outer surface, and the dye is disposed on the outer surface.

18. The tire of claim 1, wherein the layer is comprised of rubber, and the rubber is selected from the group consisting of natural and synthetic rubbers.

19. The tire of claim 18, wherein the rubber is selected from the group consisting of: polybutadienes (B R), polyisoprenes (IR), natural rubber (NR), butadiene copolymers, isoprene copolymers and mixtures thereof.

20. The tire of claim 18, wherein the rubber is selected from the group consisting of: butadiene-styrene copolymers (SBR), butadiene-isoprene copolymers (BIR), isoprene-styrene copolymers (SIR) and isoprene-butadiene-styrene copolymers (SBIR).

21. The tire of claim 1, wherein the fluorescent dye is selected from the group consisting of TRY-33 (CAS No. 801-00023-5021-P), TRY-53, and MT-6172-IB.

22. The tire of claim 1, wherein the layer comprises carbon black.

23. The tire of claim 1, wherein the tire is selected from the group consisting of cured and uncured tires.

24. A method of inspecting a tire which includes elastomeric layers comprising the steps of:
(a) including a dye that fluoresces upon exposure to ultraviolet light in an elastomeric layer of a tire;
(b) exposing the layer to ultraviolet light;
(c) inspecting the positioning of the fluorescent layer relative to another layer.

25. A method of inspecting a rubber product including layers comprising the steps of:
(a) including a dye that fluoresces upon exposure to ultraviolet light in a rubber layer of the product;
(b) exposing the layer to ultraviolet light;
(c) inspecting the positioning of the fluorescent layer relative to another layer.

26. A tire comprising a tread, wherein the tread comprises a dye which fluoresces upon exposure to ultraviolet light.

27. The tire of claim 26, wherein the tread comprises two or more layers, and at least one layer comprises a dye which fluoresces upon exposure to ultraviolet light.
